(19) United States
(12) Patent Application Publication
(10) Pub. No.: US 2025/0340078 A1
(43) Pub. Date: Nov. 6, 2025

(54) TAPE TRANSFER APPARATUS AND METHOD OF OPERATION

(71) Applicant: Dover Europe Sàrl, Vernier (CH)

(72) Inventor: Mohammed Jamal Toudmeri, Nottingham (GB)

(21) Appl. No.: 19/128,158

(22) PCT Filed: Nov. 8, 2023
(86) PCT No.: PCT/EP2023/081229

§ 371 Date: May 7, 2025

(30) Foreign Application Priority Data
Nov. 8, 2022 (GB) 2216618.5
Jul. 7, 2023 (GB) 2310512.5

(51) Int. Cl. B41J 33/04; B41J 33/00; B41J 33/16; B41J 35/38

(52) U.S. Cl. CPC B41J 33/04; B41J 33/003; B41J 33/16; B41J 35/38

(57) ABSTRACT

A tape transfer apparatus (10, 110, 210) including a body (11, 111, 211) and two spool supports (14, 16, 114, 116, 214, 216) each of which is suitable for supporting a spool of tape (18, 20, 118, 120, 218, 220) and a tape drive apparatus which is operable to transfer tape between spools (18, 20, 118, 120, 218, 220) supported on the spool supports (14, 16, 114, 116, 214, 216), characterised in that a position of at least one of the spool supports (14, 16, 114, 116, 214, 216) relative to the body (11, 111, 211) is adjustable; and a method of operating such a tape transfer apparatus (10, 110, 210), including controlling the rotation of each of the spool supports (14, 16, 114, 116, 214, 216) to enable tape to be transferred from one spool (18, 20, 118, 120, 218, 220), mounted on a respective spool support (14, 16, 114, 116, 214, 216), to another spool (18, 20, 118, 120, 218, 220), mounted on the other spool support (14, 16, 114, 116, 214, 216), and controlling a drive mechanism that is operable to adjust the position of at least one of the spool supports relative to the body.

### FIELD

The present disclosure relates to a tape transfer apparatus and a method of operation of a tape transfer apparatus, in particular, but not exclusively, to a tape transfer apparatus of a transfer printing apparatus. The present disclosure also relates to a method of determining the diameter of a spool of tape which may be accommodated in a tape transfer apparatus.

### BACKGROUND

The transfer of tape from one spool to another, in so-called [symbol] reel to reel [symbol] devices is well known. Such tape transfer is used in a printing apparatus which utilises a printing tape or “ribbon” which includes a web carrying marking medium, e.g. ink, and a printhead which, in use, removes marking medium from selected areas of the web to transfer the marking medium to a substrate to form an image, such as a picture or text. The transfer of ink from the tape to the substrate may be through a thermal transfer process, in which the printhead includes a plurality of thermal heating elements which are selectively energisable by a controller during printing to warm and soften pixels of ink from the tape and to transfer such pixels to the substrate. The printhead presses the tape against the substrate such that the pixels of ink contact the substrate before the web of the tape is peeled away, thus transferring the pixels of ink from the tape to the substrate.

Such printing apparatus includes drive apparatus for moving the tape relative to the printhead, to present fresh tape, from which pixels of ink are yet to be removed, to the printhead, such that successive printing operations can be carried out. It has long been known to provide tape drives which include two spool supports, one of which supports a supply spool on which unused tape is initially wound, and the other of which supports a take-up spool, onto which the tape is wound after it has been used. Tape extends between the spools in a tape path. Each of the spool supports, and hence each of the spools of tape, is typically drivable by a motor.

Thermal transfer overprinting (TTO) technology is popular in product packaging and labelling. The printing apparatus is typically mounted inside a packaging machine, for example on a bracket. The maximum overall dimensions of a printing apparatus have become de facto standardised, and therefore the designers and/or manufacturers of transfer printing apparatus are constrained by these dimensions when designing or configuring printing apparatuses.

The longer the tape, the more printing operations can be carried out using the tape, and, typically, the longer a tape will last before it needs to be replaced. Therefore the longer the tape, the more efficient the printing apparatus can be, since [symbol] downtime [symbol] whilst a used tape is replaced with a fresh one happens less frequently. This is more environmentally friendly, too, as there are fewer cores on to which the tape is wound manufactured and disposed of.

The use of the space available inside a reel to reel device of any kind, in particular a printing apparatus is important, too. The overall size of an apparatus may be limited by the application in which the apparatus is being used. There is a general desire to reduce the space taken up by printing apparatuses in production lines, for example. The thickness of a typical tape or ribbon is already extremely thin, which makes it susceptible to damage during printing operations and/or during maintenance procedures. Therefore, reducing the thickness further, to increase the amount of tape which can be accommodated in the space available inside the apparatus is undesirable.

### BRIEF DESCRIPTION OF THE INVENTION

There is provided a tape transfer apparatus including a body and two spool supports each of which is suitable for supporting a spool of tape, and a tape drive apparatus which is operable to transfer tape between t spools supported on the spool supports, characterised in that a position of at least one of the spool supports relative to the body is adjustable.

The position of the at least one spool support may be adjustable relative to the position of the other spool support.

The position of each spool support may be adjusted relative to the body whilst a distance between the spool supports remains substantially constant.

The position of the or each spool support may be adjusted in accordance with the diameter of a respective spool of tape mounted on the spool support.

The tape transfer apparatus may include a spool support carriage upon which at least one of the spool supports is mounted, the spool support carriage being moveable relative to the body to adjust the position of the or each spool support mounted thereon relative to the body.

The tape transfer apparatus may include at least one spool motor for rotating at least one of the spool supports and a position of the spool motor relative to the body may be adjustable.

Each spool support may be rotatable by a respective spool motor, and the position of each spool motor may be adjustable relative to the body.

The tape transfer apparatus may include a spool motor carriage upon which the or each spool motor is mounted, the spool motor carriage being moveable relative to the body to adjust the position of the or each spool motor mounted thereon relative to the body.

Movement of the or each spool motor to adjust the position of the or each spool motor relative to the body may correspond with movement of at least one of the spool supports relative to the body to adjust the position of the at least one spool support relative to the body.

The tape transfer apparatus may include a controller operable to control movement of a component of the tape transfer apparatus relative to the body.

The controller may be operable to control movement of the or each spool support to adjust the position of the or each spool support relative to the body.

The controller may be operable to control movement of the spool support carriage relative to the body.

The body may include a first part and a second part.

Each spool support may be mounted in one of the first part and the second part of the body and the at least one spool motor may be mounted in the other of the first part and the second part of the body.

The tape transfer apparatus may include a spool rotation holding apparatus to inhibit or prevent rotation of at least one of the spool supports.

The tape transfer apparatus may include a spool holding apparatus which may be operable to inhibit or prevent movement of at least one of the spools relative to the body.

The tape transfer apparatus may be a transfer printing apparatus.

There is provided a method of operating a tape transfer apparatus including controlling the rotation of each of the spool supports to enable tape to be transferred from one spool, mounted on a respective spool support, to another spool, mounted on the other spool support, and controlling a drive mechanism that is operable to adjust the position of at least one of the spool supports relative to the body.

The method of operating a tape transfer apparatus may include controlling the drive mechanism to control the position of at least one of the spool supports relative to the body in accordance with the diameter of the spool mounted on the at least one spool support.

Controlling the position of at least one of the spool supports may include adjusting the position of at least one of the spool supports relative to the body.

The method of operating a tape transfer apparatus may include adjusting the position of both spool supports relative to the body in accordance with the diameter of at least one of the spools.

The drive mechanism may be operable to control the position of at least one of the spools in accordance with a rate of change of diameter of at least one of the spools.

The method of operating a tape transfer apparatus may include determining the largest spool of tape which may be accommodated in the tape transfer apparatus, taking into account at least one dimension of the tape transfer apparatus.

The direction of the tape transfer apparatus may be a dimension of the body, for example a width of the body.

The method may include determining a range of adjustment of the position of at least one of the spool supports.

The method of operating a tape transfer apparatus may include adjusting the position of the at least one spool by displacing the at least one spool support substantially linearly relative to the body and/or displacing the at least one spool support substantially arcuately relative to the body.

### BRIEF DESCRIPTION OF THE FIGURES

In order that the present disclosure may be more readily understood, preferable embodiments thereof will now be described, by way of example only, with reference to the accompanying drawings, in which:

FIG. 1 is an illustrative cross-section view through a tape path of a tape transfer apparatus, with two spools of tape mounted on spool supports;

FIG. 2 is an exploded perspective view of an example of a tape transfer apparatus;

FIG. 3 is an illustrative perspective view showing parts of the tape transfer apparatus of

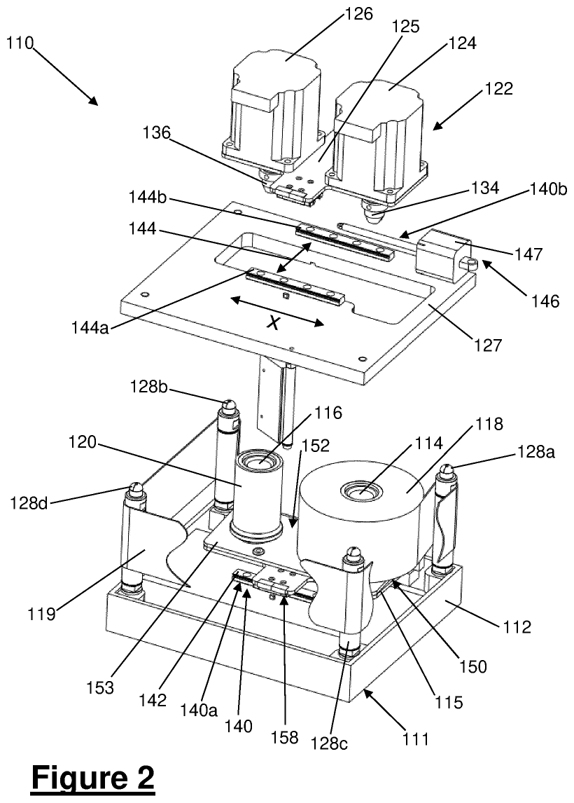

FIG. 2 assembled;

FIG. 4 is an illustrative perspective view of the tape transfer apparatus of FIG. 2, with the spools of tape removed;

FIG. 5 is an illustrative cross-section view of an example of a tape transfer apparatus;

FIG. 6 is an illustrative, exploded perspective view of the tape transfer apparatus of FIG. 5;

FIG. 7A is a side cross-section view of a tape transfer apparatus, showing a holding arrangement in a first configuration;

FIG. 7B is a side cross-section view of a tape transfer apparatus showing the holding arrangement in a second configuration;

FIG. 8A is an illustrative perspective view of a first part of the tape transfer apparatus of FIGS. 5 and 6;

FIG. 8B is an illustrative perspective view of a second part of the tape transfer apparatus of FIGS. 5 and 6;

FIG. 9A is an illustrative perspective view of an example of parts of a tape transfer apparatus; and

FIG. 9B is an illustrative perspective view of the parts of the tape transfer apparatus of FIG. 9A, but viewed from a different perspective.

### DETAILED DESCRIPTION OF THE DISCLOSURE

Referring to the figures, there are shown parts of a tape transfer apparatus 10, which, in the examples shown, is a thermal transfer printing apparatus. It will be understood that it is not essential for the tape transfer apparatus to be a printing apparatus, and the components described herein which are specific to printing operations are not essential.

The tape transfer apparatus 10 includes a body 11. The body 11 may have a width W. The body 11 may have a height H. The body 11 may include a first part. The first part may be a plate, a box section, or have any appropriate form. The first part of the body 11 may include a chassis or base plate. The first part may have a width W. The body 11 may include a removeable cassette. The first part of the body 11 may be the cassette or may be a part of the cassette. The body 11 may include a second part, which may be configured to co-operate with the first part, to form a housing for tape spools 18, 20. Where the apparatus 10 is a printing apparatus, a printhead 30 may also be housed in the body 11. The second part of the body 11 may include a back plate. The second part of the body 11 may include a wall. The wall may extend along one or more sides (edges) of the back plate. The second part of the body 11 may be installed in a production line, for example, and the first part of the body 11 may be engageable with and disengageable from the second part 13 of the body 11, to enable maintenance, for example.

The apparatus 10 includes a first spool support 14 and a second spool support 16. Each spool support 14, 16 may be a rotatable spindle, for example. Each spool support 14, 16 is configured to receive a spool 18, 20 of tape 19. Each spool support 14, 16 may be mounted on a spool support carriage 15. The spool support carriage 15 may be attached to the first part of the body 11. The spool supports 14, 16 may be positioned in a tape mount zone Z_{T} of the body 11. The tape mount zone Z_{T} may have a width W_{T} and a height H_{T}. The width W_{T} of the tape mount zone Z_{T} may be the same as or different from the width W of the body 11. Centres of the spool supports 14, 16 may be spaced apart by a distance B.

A tape drive apparatus 22 is provided to enable the movement of the tape 19, and/or to support or facilitate control of components of the tape transfer apparatus 10. The spool supports 14, 16 may be driven, e.g., rotated, by the tape drive apparatus 22. The tape drive apparatus 22 may include one or more spool motors 24, 26, which may be of any appropriate type, for example one or more stepper motors. In the example shown, each spool motor 24, 26 corresponds with a respective spool support 14, 16, to rotate the corresponding spool support 14, 16. The or each spool motor 24, 26 may be coupled to its corresponding spool support(s) 14, 16 by a coupling. Each coupling may be received by a part of the corresponding spool mount 14, 16.

The tape drive apparatus 22 is operable to rotate the spool supports 14, 16, so as to transfer tape 19, e.g., inked ribbon, between the spools 18, 20. Appropriate methods of control of the tape drive apparatus 22 so as to transfer tape 19 between the spools 18, 20 may be such as those known in the art. The or each spool motor 24, 26 of the tape drive apparatus 22 may be controlled by a spool control apparatus.

The tape transfer apparatus 10 shown in the figures is a printing apparatus, and therefore a printhead 30 is included. A peel off roller 32 is also provided near to the printhead 30, in a typical printing apparatus arrangement.

Where provided, the printhead 30 may be arranged to carry out continuous and/or intermittent printing. The printhead 30 may be located in a printhead zone Z_{P}. The peel off roller 32 may be located in the printhead zone Z_{P}. The printhead zone Z_{P} may have a width W_{P} and a height H_{P}. The width W_{P} of the printhead zone Z_{P} may be the same as or different from the width W of the body 11 and/or the same as or different from the width W_{T} of the tape zone Z_{T}. The printhead zone Z_{P} may be adjacent the tape zone Z_{T}.

The printhead 30 (when the apparatus 10 is a printing apparatus) may be mounted on a printhead carriage which may be moveable relative to the body 11, for example in a back and forth direction relative to the body 11 and/or between non-printing and printing positions (for example, substantially into and out of contact with the tape, to perform printing operations). Movement of the printhead 30 into and out of contact with the tape 19 may include substantially linear and/or rotational movement. Movement of the printhead 30 relative to the body 11 may be carried out wholly or substantially within the printhead zone Z_{P}. Movement of the printhead 30 relative to the body 11 may be enabled by a printhead drive apparatus. The printhead drive apparatus may include one or more printhead drive motors. The printhead drive apparatus may include one or more pulley wheels, belts, etc., as is known in the art.

It will be understood that the present disclosure is appropriate for tape transfer apparatus other than a printing apparatus, and thus a printhead is not an essential feature, and nor is a peel off roller.

The tape 19 extends between the spools 18, 20 in a tape path. The tape transfer apparatus 10 may also include one or more guide members 28 which may be configured to define at least a part of the tape path. The present disclosure includes four guide members 28a-d, each one being positioned near to a respective corner of the body 11. It will be understood that any appropriate number and arrangement of guide members 28 may be provided. Each guide member 28 may have a respective radius R_{G}.

One or more of the guide members 28 may co-operate with the tape drive apparatus 22. For example, one or more of the guide members 28 may include a sensor device or a part of a sensor device, for example to assist with determination of the speed of the tape 19 as it is moves between the spools 18, 20. One or more of the guide members 28 may be operable to rotate, actively and/or passively (for example to urge the tape to be moved, and/or to be rotated by the tape moving past and/or around it). Each guide member 28a-d may be fixed relative to the first part 12 of the body 11. One or more of the guide members 28 may be moveable relative to the first part 12 of the body 11. One or more of the guide members 28 may be used to measure tension in the tape 19.

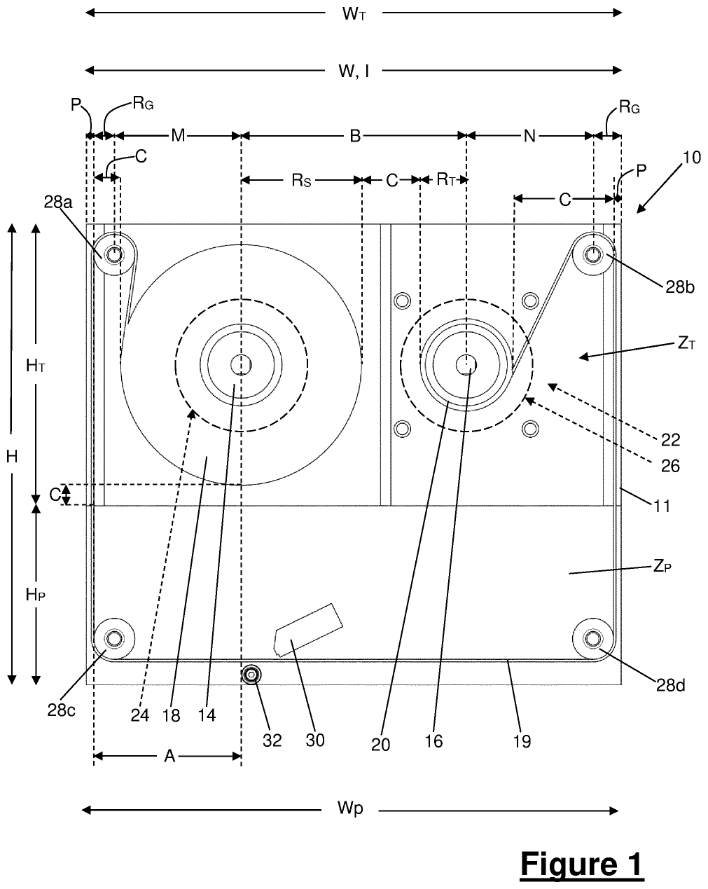

In the example shown, two guide members 28a, 28b are positioned in the tape zone Z_{T} and two guide members 28 are positioned in the printhead zone Z_{P}. A distance M separates the first spool support 14 from a first guide member 28a. The distance M may be measured from the centre of the spool support 14 to the centre of the first guide member 28a. A distance N separates the second spool support 16 from a second guide member 28b. The distance N may be measured from the centre of the second spool support 16 and the second guide member 28b. A distance P may be provided between each guide member 28 and an adjacent wall of the body 11. The distance P is intended to provide clearance, i.e. to ensure that the tape 19 does not contact the body 11 of the apparatus 10 as it is moving along the tape path. The position of the or each guide member 28 and/or the or each spool support 14, 16 may be selected so as to provide a clearance between each adjacent section of tape 19 in the tape path (adjacent in this case does not mean touching, as when wound on to a spool 18, 20). The distances B, M and N may be determined accordingly. As shown in FIG. 1, for example, the distances B, M, N, P are substantially parallel to one another, and substantially parallel with the width of the body 11.

As mentioned above, the spool supports 14, 16 are positioned in a tape mount zone Z_{T}. The tape mount zone Z_{T} is not necessarily physically separated from the printhead zone Z_{P}, however, it is advantageous for the area surrounding the spools 18, 20 to be as free from obstructions, etc. as possible. Unintentional mechanical interference with the tape 19 may damage the tape 19, slow the tape 19 and/or affect the ability of the tape drive apparatus 22 to operate effectively and/or as required. Intentional or necessary interference might be, for example, contact between the tape 19 and the printhead 30 to carry out a printing operation and/or contact with a guide member to transfer the tape 19 in the tape path.

The diameter of each of the spools 18, 20, as tape is transferred from one spool support 14, 16 to the other, is an important characteristic. For example, where stepper motors are used to control the tape transfer drive apparatus 22, the amount of tape wound on to or unwound from a spool 18, 20 with each rotation (and each step) will vary dependent upon the diameter of the spool 18, 20 at that time.

Of course, as the tape is transferred from one spool 18, 20 to the other, the diameter of the supply spool decreases and the diameter of the take up spool increases. When the tape 19 is inserted into the apparatus 10 (for example by insertion of the cassette), the supply spool may hold substantially all of the tape 19, and the take up spool may hold almost none. The diameter and radius of a full spool are D_{f} and R_{f}, respectively. Once the tape 19 has been used, the opposite situation may be true, i.e. the supply spool may hold almost no tape and almost all of the tape 19 may be held by the take up spool. At a mid-point in the transfer of tape 19 between the spools 18, 20, the amount of tape 19 in each spool may be approximately equal. It will be understood that the tape 19 may be transferred in either direction, and that from time to time, tape 19 may be rewound on the supply spool and/or unwound from the supply spool. However, for simplicity, the take up and supply spool are referred to generally, herein.

The applicant has devised a method of determining the maximum full diameter (D_{fmax}) of tape which may be accommodated in a tape transfer apparatus. The method takes into account the fact that the tape 19 may be transferred from a substantially full spool to an empty or substantially empty spool. The method also takes into account that the tape extends in a tape path between the spools, and it is preferable to include a clearance between sections of tape which are located adjacent one another.

Referring to FIG. 1, the apparatus 10 is shown in a first arrangement of spool supports 14, 16, corresponding spools 18, 20 and guide members 28 around which the tape 19 passes in a tape path. The printhead 30 and peel off roller 32 are also present since, in the example shown, the apparatus 10 is a printing apparatus. The distance A between the centre of each spool support 14, 16 (and hence the centre of each spool 18, 20) and the tape 19 extending in the tape path adjacent the respective spool 18, 20 is:

$$A \geq \frac{{D}_{f}}{2} + c \qquad Equation 1$$

where D_{f} is the full diameter of the spool 18, 20 (i.e. when substantially all of the tape 19 is wound on to that spool), and c is a minimum clearance distance between the outer circumference of the spool 18, 20 and the tape 19 in the tape path adjacent the spool 18, 20 and/or a minimum clearance between the outside diameters of the spools 18, 20. The clearance distance c may be between approximately 1 mm and approximately 5 mm, for example between approximately 2 mm and 4 mm. It will be understood that each spool 18, 20 may not have a perfectly circular cross section, i.e. each spool 18, 20 may have an eccentricity. However, for the purposes of the present calculations, the spools 18, 20 may be approximated as having a substantially circular cross-section.

The distance B between the centres of the two spools 18, 20 needs to accommodate the sum of the radii of both spools 18, 20, with a clearance c between the spools at any time and can be represented by Equation 2:

$$B = {R}_{s} ( t ) + {R}_{t} ( t ) + c \qquad Equation 2$$

Where Rₛ(t) and Rₜ(t) are the instantaneous outer radii of the [symbol] supply [symbol] and [symbol] take-up [symbol] spools, respectively, as a function of time.

Equation 2 may be used to determine a minimum spacing Bₘᵢₙ between the spool supports 14, 16.

The applicant has established that the distance B tends to its maximum value Bₘₐₓ, i.e., the distance needed between the centres of the spools to accommodate the spools 18, 20 simultaneously is greatest when:

$${R}_{s} = {R}_{t} \qquad Equation 3$$

In this configuration, the volume of tape 19, and hence the length of tape 19, carried by each spool support 14, 16 is substantially equal. This configuration occurs when the cross-sectional area of tape on each of the spools is approximately half of the maximum (or [symbol] full [symbol] ) cross-sectional area. Of course, the cross sectional area of the spool is dependent upon its radius. It will be appreciated that the length of tape 19 in the tape path may be considered to be negligible for the present calculations, since it is very small compared with the total length of the tape 19.

Rₕ is the outer radius of the spool 18, 20 when half of the tape is wound on that spool 18, 20, and can be expressed as follows:

$${R}_{h}^{2} = \frac{{R}_{f}^{2} + {r}^{2}}{2} \qquad Equation 4$$

Where R_{f} is the outer radius of the spool which occurs when a spool is [symbol] full [symbol] , i.e. substantially all of the tape 19 is wound on to one spool 18, 20 and the other spool 18, 20 is substantially empty, and r is the inner radius of the spool 18, 20. R_{f} is, of course, half of the diameter of the spool when full D_{f}. The inner radius r of each spool 18, 20 may be defined by the outer radius of a core which may be mounted on one of the spool supports 14, 16, and on to which the tape 19 may be wound.

If we treat each spool 18, 20 as a cylinder, the volume v of tape on each spool may be approximated as follows:

$$v = π \cdot ( {R}^{2} - {r}^{2} ) \cdot w \approx L \cdot T \cdot w \qquad Equation 5$$

### Where:

is the volume of a spool;
R is the outer spool radius;
r is the inner spool radius;
L is the length of tape in the spool;
T is the tape thickness; and
w is the width of the tape.

Therefore, the outer radius of a spool can be represented as follows:

$$R = \frac{D}{2} = \sqrt{\frac{L . T}{π} + {r}^{2}} \qquad Equation 6$$

Where D is the outer spool diameter.

Rearranging the above equations, the minimum distance Bₘᵢₙ between the centres of the spools 18, 20 (and hence between the spool supports 14, 16) can be expressed as follows:

$${B}_{min} = 2 {R}_{h} + c = 2 \sqrt{\frac{L . T}{2. π} + {r}^{2}} + c \qquad Equation 7$$

Where c is a minimum clearance between adjacent sections of tape (for the avoidance of doubt, in this sense, [symbol] adjacent [symbol] does not mean successive layers of tape on the spool).

The width W of the apparatus 10, can be expressed as follows:

$$W = 2 P + 2 T + 2 c + 2 {R}_{f} + B \qquad Equation 8$$

$$i . e . \qquad W = 2 P + 2 T + 2 {R}_{f} + 2 {R}_{h} + 3 c$$

Where P is a minimum distance between the tape path and an adjacent wall of the apparatus 10.

It will be appreciated that a single thickness T of tape 19 in the tape path may be neglected hereinafter, as a single thickness of tape 19 is approximately 5 to 10 microns.

Substituting equation 7 into equation 8 gives:

$$W = 2 ( P + \sqrt{\frac{L . T}{π} + {r}^{2}} + \sqrt{\frac{L . T}{2. π} + {r}^{2}} ) + 3 c \qquad Equation 9$$

An effective width Wₑ (which is the total width of both spools 18, 20 mounted on their corresponding spool supports 14, 16,) can be expressed a follows:

$${W}_{e} = W - 2 P - 3 c \qquad Equation 10$$

And simplifying gives:

$${W}_{e} = 2 ( {R}_{f} + {R}_{h} ) \qquad Equation 11$$

From Equation 4 and Equation 11 it can be seen that the maximum full tape spool diameter which can be accommodated is

$${D}_{f max} = 2 ( {W}_{e} - \sqrt{\frac{{W}_{e}^{2}}{2} + {r}^{2}} ) \qquad Equation 12$$

$$Or$$

$${R}_{f max =} {W}_{e} - \sqrt{\frac{{W}_{e}^{2}}{2} + {r}^{2}} \qquad Equation 13$$

And the minimum distance Bₘᵢₙ between the two spools 18, 20 (and therefore between the spool supports 14, 16) can be expressed as follows:

$${B}_{min} = 2 {R}_{h} + c = \sqrt{2 ( {R}_{f max}^{2} + {r}^{2} )} + c \qquad Equation 14$$

The distance B may be optimised for the length of tape and the width of the apparatus 10, using this relationship. The distance c is the minimum clearance required between adjacent lengths of tape 19. The actual distance between adjacent lengths of tape will vary as the diameters of the spools 18, 20 change, as can be seen in FIG. 1.

Thus, the applicant has devised a method of determining the maximum spool diameter which can be accommodated in an apparatus 10 having a body (or tape mount zone Z_{T}) having a width W, and determined the minimum separation of spool supports to accommodate a tape having a certain length and/or spool outer radius.

The applicant has devised methods and apparatus for dynamic adjustment of the position of the spools 18, 20 in the printing apparatus 10. The applicant has devised methods and apparatus for dynamic adjustment of the position of the spools 18, 20 within the tape mount zone Z_{T}. The methods enable the optimization of the length of tape (which governs the full spool radius) that can be accommodated in the space available. The methods may enable the maximum length of tape which can be accommodated in the space available to be determined and/or used. The methods may enable the length of tape that can be accommodated in the space available to be maximised.

The applicant has discovered that it is possible to accommodate larger diameter spools in the apparatus 10 by adjusting the position of parts of the tape drive apparatus 22 relative to the body 11, for example by moving one or both of the spool supports 14, 16 relative to the body 11 as tape is transferred from one spool 18, 20 to the other, compared with if the spool supports 14, 16 remain stationary. There are three possibilities for adjustment of the position of the spools 18, 20: the first is to maintain the spacing, i.e. the distance B, between the spool supports 14, 16, substantially constant, whilst moving both spools 18, 20 relative to the body 11; the second is to adjust the spacing B between the spools 18, 20 by moving the spool supports 14, 16 relative to one another; and the third possibility is to combine adjustment of the spacing B with movement of the spool supports 14, 16 relative to the body 11.

The applicant has determined that the advantage provided by moving both spools 18, 20 (by moving their corresponding spool supports 14, 16) relative to the body 11 is greater than that achievable by moving the spools 18, 20 relative to one another as tape 19 is transferred from one spool to the other.

The applicant has devised apparatus to enable each of the spool supports 14, 16 (and their associated spools 18, 20) to move relative to the body 11, for example linearly and/or arcuately. An example tape transfer apparatus 110 is shown in FIGS. 2-4.

The tape transfer apparatus 110 operates in the general manner described above. The tape transfer apparatus 110 includes two spool supports 114, 116, configured to support a respective spool of tape 118, 120. A tape drive apparatus is operable to transfer tape from one spool 118, 120, to the other spool 118, 120. The tape transfer apparatus 110 may include all of the features described in relation to the tape transfer apparatus 10 [symbol] each corresponding feature has the same reference numeral, with the prefix [symbol] 1 [symbol] . The apparatus may be configured to enable parts of the tape drive apparatus 122 to move relative to the body 111. The apparatus 110 may be configured to enable adjustment of the position of one or both of the spool supports 114, 116 relative to the body 111. A first part 112 of the body 111 is shown in FIG. 2 and FIG. 4. The tape transfer apparatus 111 may be configured such that the or each spool motor 124, 126 of the tape drive apparatus 122 is able to move relative to the body 111 in a corresponding manner, e.g. to move with the corresponding spool support 114, 116.

The tape transfer apparatus 111 may be configured to enable substantially linear movement of each spool support 114, 116 relative to the body 111.

Each of the spool supports 114, 116 may be mounted on a spool support carriage 115. The spool support carriage 115 may be a plate. The spool support carriage 115 may be attached directly or indirectly to the first part 112 of the body 111. The spool support carriage 115 may be moveable relative to the first part 112 of the body 111. Movement of the spool support carriage 115 may cause or enable movement of one or both spool supports 114, 116 (and hence any corresponding spools 118, 120, mounted thereon), relative to the body 111. The spool support carriage 115 may be moveable linearly and/or arcuately relative to the first part 112 of the body 111. In the example shown in FIGS. 2-4, the spool support carriage 115 is configured to enable linear movement of the spool supports 114, 116 relative to the body 111.

In the present example, each spool motor 124, 126 has a [symbol] radius [symbol] Rₘ (it will be appreciated that each spool motor need not be circular, but that the width Rₘ is half the width of one of the spool motors 24, 26). The width (or [symbol] radius [symbol] Rₘ) of each spool motor 124, 126 may determine the maximum amount of movement of the spool supports 114, 116. For example, each spool motor 124, 126 has a fixed size, which may be larger than the minimum outer radius R of each spool 118, 120. Therefore the size of one or both of the spool motors 124, 126 may be a limiting factor in the displacement of the or each spool support 114, 116 relative to the body. For example, if the spool radius/diameter were used to determine the maximum or optimum amount of movement of the spool supports 114, 116 relative to the body 111, the size of one or both of the spool motors 124, 126 may inhibit such movement.

Assuming the motor [symbol] radius [symbol] Rₘ (or half motor width) is less than the inner spool radius r, then the effective width Wₑ is dependent upon the radii of the spools:

$${W}_{e} = {R}_{f} + 2 {R}_{h} + r \qquad Equation 15$$

Subsequently, the maximum full spool radius that can be accommodated is

$${R}_{f max} = \sqrt{2 ( {( {W}_{e} - r )}^{2} - {r}^{2} )} - {W}_{e} + r \qquad Equation 16$$

Otherwise, if the width of the motor is greater than the minimum spool radius rₘᵢₙ (which is the same as the outer diameter of the core), which is often the case, then taking the motor width into account gives an effective width:

$${W}_{e} = {R}_{f} + 2 {R}_{h} + {R}_{m} \qquad Equation 17$$

And the maximum full spool radius R_{fmax} becomes:

$${R}_{f max} = \sqrt{2 ( {( {W}_{e} - {R}_{m} )}^{2} - {r}^{2} )} - {W}_{e} + {R}_{m} \qquad Equation 18$$

In the example shown, each spool support 114, 116 is driven by a corresponding spool motor 124, 126. It will be understood that this is not essential, and that a single spool motor may be provided, for example. The or each spool motor 124, 126 may be mounted on a spool motor carriage 125. Since the spool supports 114, 116 are configured for movement relative to the body 111, the corresponding spool motors 124, 126 may also be configured to move relative to the body 111, for example, in a manner corresponding to the movement of the spool supports 114, 116. The spool motor carriage 125 may be configured for movement relative to the body 111 in a manner corresponding with the movement of the spool support carriage 115. The spool motor carriage 125 may include an opening configured to receive a part of each of the motors 124, 126 and/or a part of the corresponding coupling 134, 136 to enable each motor 124, 126 to be coupled with the corresponding spool support 114, 116. The spool motor carriage 125 may include an opening corresponding with each spool motor 124, 126. Each coupling 134, 136 may extend through a respective opening 125a, 125b in the spool motor carriage 125.

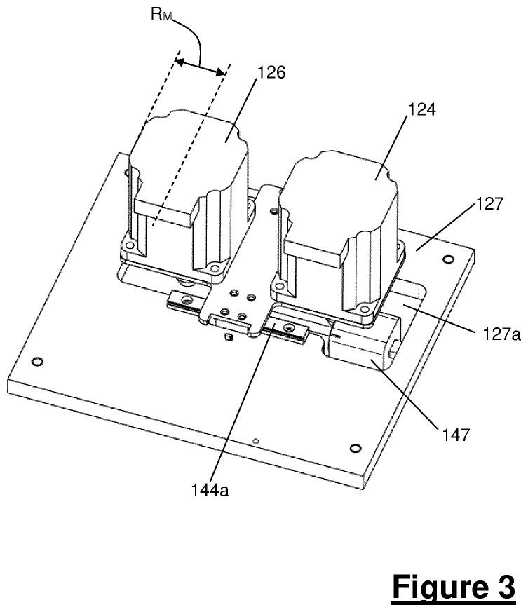

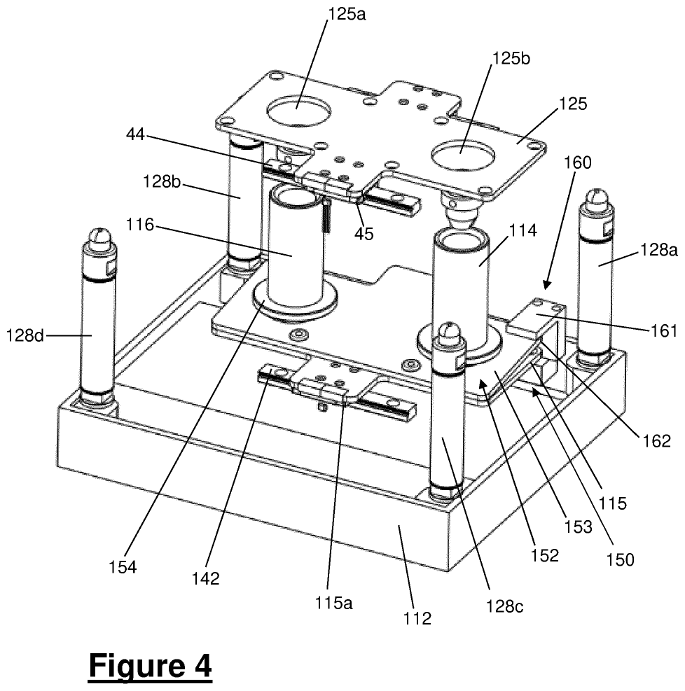

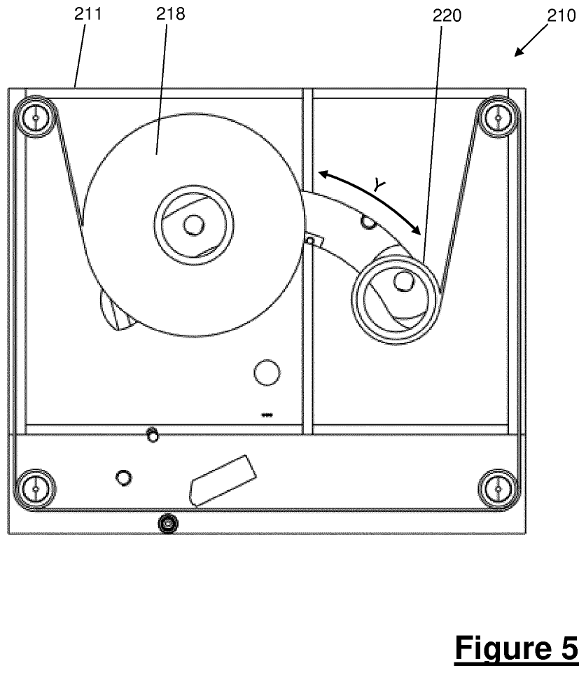

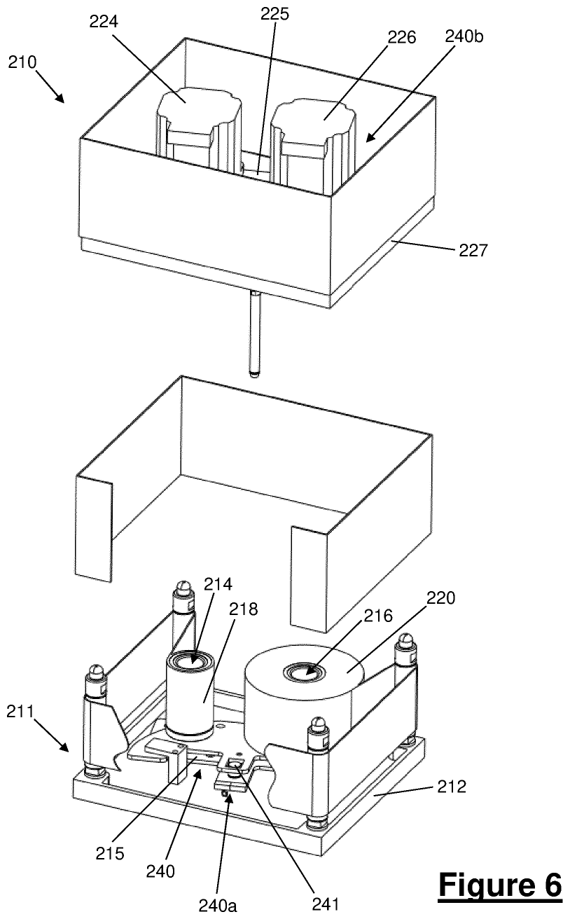

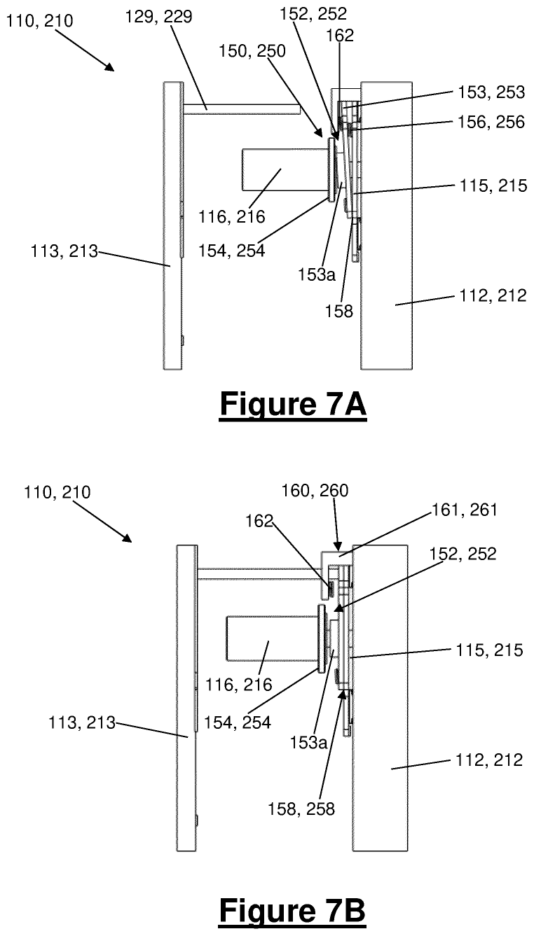

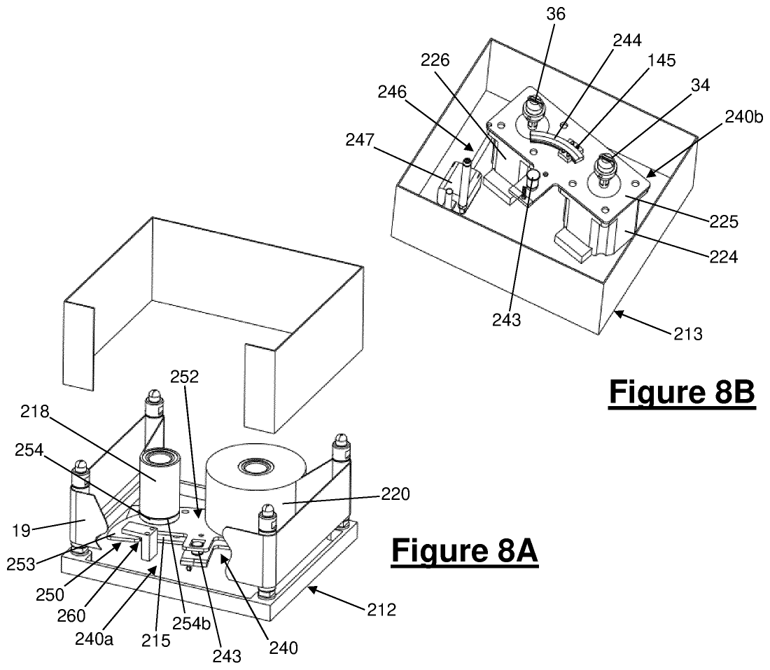

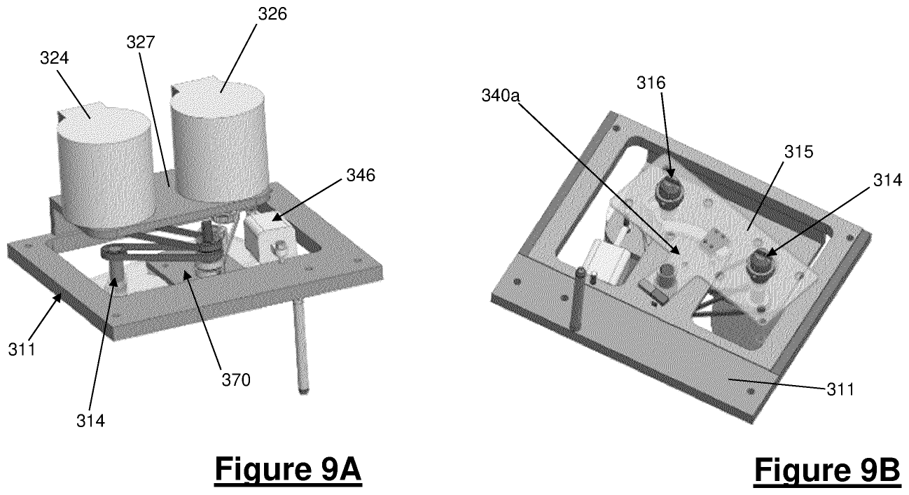

The spool motor carriage 125 may be attached to a motor supporting member 127. The motor supporting member 127 may be a part of the body 111. The motor supporting member 127 may be a part of a second part of the body 111. The motor supporting member 127 may include an aperture 127a through which a part of the or each motor 124, 126 and/or the or each coupling 134, 136 may extend. The motor supporting member 127 may support other parts of the apparatus 110. See FIG. 3, for example.

A spool assembly may include at least one of the spool supports 114, 116 upon each of which may be mounted a spool 118, 120 of tape 119; the spool support carriage 115; one or more spool motors 124, 126, each including respective coupling 134, 136 to couple the or each motor 124, 126 to the corresponding spool support 114, 116; and the spool motor carriage 125. The apparatus 110 may include a pair of spool assemblies, each spool assembly corresponding with one of the spool supports 114, 116 and its associated spool 118, 120. The apparatus 110 may include a single spool assembly which includes both spool supports 114, 116, etc.. The or each spool support assembly may be configured when the two parts of the body 111 are engaged with one another (where the body 111 is provided in two parts), or when the spools 118, 120 are mounted on the spool supports 114, 116, for example. The engagement of the first and second parts of the body 111 may include coupling the or each spool motor 124, 126 with its corresponding spool support 114, 116, for example via the or each respective coupling 134, 136.

The apparatus 110 may include a spool assembly transport arrangement 140. The spool assembly transport arrangement 140 may be operable to move one or more spool assemblies, e.g. one or both spool supports 114, 116, with a spool 118, 120 of tape 119 corresponding with the or each spool support 114, 116; and or one or more spool motors 124, 126 and/or the spool support carriage 115 and/or the spool motor carriage 125, relative to the body 111 or a part of the body 111, for example the first part 112, the second part (where provided) and/or the motor supporting member 127. The spool assembly transport arrangement 140 may enable the or each spool support 114, 116 (and a corresponding spool 118, 120) to move together with the or each respective spool motor 124, 126, or independently therefrom.

In examples (for instance as shown in FIGS. 2-4), the spool assembly transport arrangement 140 may be arranged to enable movement of the or each spool assembly relative to the body 111. Each spool support 114, 16 may be moveable relative to the body 111. The or each spool assembly may be moveable relative to the body 111. In examples, the spool support carriage 115 and the spool motor carriage 125 may be configured to move back and forth relative to the body 111, for example in directions indicated by the double headed arrow marked X in FIG. 2. The configuration of the spool assembly transport arrangement 140 may enable the movement each spool assembly substantially linearly relative to the body 111.

The spool assembly transport arrangement 140 may include a spool transport assembly 140a to enable movement of one or both of the spool supports 114, 116 and their respective spools 118, 120 relative to the body 111. The spool transport assembly 140a may include or co-operate with the spool support carriage 115. The spool transport assembly 140 may include a first track 142. The first track 142 may include a rail or a pair of rails, for example. The track 142 may be fixed to the body 111. The track 142 may be fixed to the first part 112 of the body 111, for example. The track 142 may extend substantially linearly relative to the body 111. The track 142 may extend substantially laterally relative to the body 111, and may extend across at least a proportion of the width W of the body 111. The spool support carriage 115 may be attached to or otherwise co-operate with at least a part of the spool assembly transport arrangement 140 for movement relative thereto, and relative to the body 111. The spool support carriage 115 may include a formation 115a which co-operates with the track 142 to facilitate movement of the spool support carriage 115 relative to the body 111.

The spool assembly transport arrangement 140 may include a spool motor transport assembly 140b to enable the movement of one or both of the spool motors 124, 126 relative to the body 111. The spool motor transport assembly 140b may include or co-operate with the spool motor carriage 125. The spool motor transport assembly 140b may include a second track 144. The second track 144 may include a rail or a pair of rails 144a, 144b, for example. The second track 144 may be substantially linear. The second track 144 may be substantially parallel with the first track 142. The spool motor carriage 125 may include a formation 145 which co-operates with the second track 144 to facilitate movement of the spool motor carriage 125 and the or each motor 124, 126 mounted thereto, relative to the body 111. The spool motor carriage 125 may be moveable substantially linearly relative to the body 111 along the second track 144. The second track 144 may be fixed to a part of the body 111. The second track 144 may be fixed to the motor supporting member 127. The second track 144 may be fixed adjacent the opening 127a in the motor supporting member 127. The opening 127a may be elongate so as to permit movement of the or each spool motor 124, 126 relative to the body 111.

The spool assembly transport arrangement 140 may include a drive mechanism 146. The drive mechanism 146 may include one or motors 147. The drive mechanism may include a transmission. The drive mechanism 146 may be operable to enable movement of the or each spool assembly relative to the body 111, for example by enabling movement of the spool support carriage 115 relative to the first track 142 and/or movement of the spool motor carriage 125 along the second track 144.

The tape transfer apparatus 110 may include a holding arrangement 150 to inhibit or prevent movement of the spool supports 114, 116 relative to the body 111.

The holding arrangement 150 may be operable to inhibit or prevent movement of the spool supports 114, 116 relative to the body 111 when the spools 118, 120 are not mounted on the spool supports 114, 116, for example when the first part 112 of the body 111 (which may be a cassette) is not engaged. The holding arrangement 150 may include a spool rotation holding arrangement to inhibit or prevent rotation of the or each spool support about its own axis of rotation. The holding arrangement may include a spool assembly holding assembly to inhibit or prevent movement of the or each spool assembly, or parts thereof, relative to the body, for example to inhibit or prevent linear, arcuate or curvilinear displacement of the or each spool assembly relative to the body.

An example of the holding arrangement 150 is shown in FIGS. 2, 4, 7A and 7B. for example. The holding arrangement 150 may include a spool rotation holding arrangement 152. The spool rotation holding arrangement 152 may be configured to inhibit or prevent rotation of one or both spool supports (and any spools 118, 120 of tape 119 mounted thereon). The spool rotation holding arrangement 152 may thus inhibit or prevent the winding or unwinding of tape from or on to each spool 118, 120.

The spool rotation holding arrangement 152 may include a holding member 153 that is engageable with one or both spool supports 114, 116. The holding member 153 may be attached to the body 111, for example the first part 112 of the body, and/or attached to the spool support carriage 115. The holding member 153 may be attached to the spool support carriage 15 and/or may be attached to the body 111, for example to the first part 12 of the body 111.

The holding member 153 may include a plate. The plate may have a similar shape to the spool support carriage 115. The holding member 153 may be positioned between the spool support carriage 115 and the spool supports 114, 116. The plate may include an opening to receive a part of at least one of the spool supports 114, 116. The plate may include a pair of openings, each opening being configured to receive a part of a corresponding spool support 114, 116.

The holding member 153 may include an engagement member 153a. The holding member 153 may include a pair of engagement members 153a. The or each engagement member 153a may be associated with a corresponding spool support 114, 116 and may be configured to engage with a part of the corresponding spool support 14, 16. The or each spool support 114, 116 may include an engagement formation 154. The or each engagement formation 154 may be a disc or collar, for example. Additionally or alternatively, the or each engagement member 153a may be configured to engage a part of a spool 118, 120 of tape supported by a corresponding one of the spool supports 114, 116. The or each engagement member 153a may include an opening to receive a part of the corresponding spool support 114, 116. The or each engagement member 153a may be substantially annular. A first face of the or each engagement member 153a may be attached to the plate. The first face of the or each engagement member 153a may be fixed to the plate such that the or each engagement member 153a remains substantially stationary relative to the plate. A second face of the or each engagement member 153b may be configured such that at least a part of the second face of the or each engagement member 153a is engageable with a part of the corresponding spool support 114, 116 and/or the corresponding spool 118, 120.

The holding member 153 may be moveable relative to the or each spool support 114, 116 and/or associated spool 118, 120 between a first holding position (as shown in FIG. 7A) and a second, release position (as shown in FIG. 7B). When the holding member 153 is in the first, holding position, the holding member 153 is operable to inhibit or prevent rotation of one or both of the spool supports 114, 116 (and corresponding spools 118, 120). When the holding member 153 is in its second, release position, the or each spool support 114, 116 is able to rotate about its axis.

The holding member 153 may be biased towards one of the first position and the second position. The spool support holding member 153 may be urged towards and/or held in its biased position by a biasing member 156. The biasing member 156 may be a spring, for instance a leaf spring, compression spring or an electromagnet, for example. The biasing member 156 may be positioned between the spool support carriage 115 and the spool supports 114, 116. The holding member 152 may be connected to the body 111 (directly or indirectly) by a connecting member 158. The holding member 153 may be attached to the body 111 for pivoting or hinged movement relative thereto. The connecting member 158 may be a hinge or pivot. The connecting member 158 may be a hinged portion of the holding member 153.

The holding arrangement 150 may include a release arrangement. The release arrangement may include a release member 129 which may co-operate with the spool rotation holding arrangement 152. The release member 129 may co-operate with the spool rotation holding arrangement 152 to release the holding member 153 from its biased position. The release member 129 may co-operate with the holding arrangement 150 when the first part 112 and the second part 113 of the body are engaged with one another and/or when the spools 118, 120 are mounted in their respective spool supports 114, 116. The release member 129 may be arranged such that when the first part 112 and the second part 113 of the body 111 are engaged with one another, the release member 129 pushes the holding member 153 out of its holding position, and towards its release position.

The apparatus 110 may include a spool assembly holding arrangement 160. The spool assembly holding arrangement 160 may inhibit or prevent movement of the or each spool support 114, 116 relative to the body 111. The spool assembly holding arrangement 160 may inhibit or prevent movement of the or each spool assembly relative to the body 111. The spool assembly holding arrangement 160 may be configured to inhibit or prevent at least one of linear, lateral, arcuate or curvilinear movement of one or both of the spool supports 114, 116 depending upon the configuration of the apparatus 110. The spool assembly holding arrangement 160 may be configured and/or operable to inhibit or prevent at least one of linear, lateral, arcuate or curvilinear movement of one or both spool assemblies relative to the body 111.

The spool assembly holding arrangement 160 may be configured and/or operable to inhibit or prevent movement of any or all of the following relative to the body 111, individually or in combination: one or both of the spool supports 114, 116, the spool support carriage 115, the or each spool motor 124, 126, the spool motor carriage 125, and/or any other parts fixed or coupled to any of the aforementioned parts.

The spool assembly holding arrangement 160 may be attached to the body 111, for example to the first part 112 of the body 111.

The spool assembly holding arrangement 160 may include a first holding formation 161 configured to engage a part of the or each spool assembly. The spool assembly holding arrangement 160 may inhibit or prevent movement of the spool support carriage 115 relative to the body 111. The first holding formation 161 may include a bracket, for example. The first holding formation 161 may be of any appropriate type, for example a clip, detent, hook, catch, anti-sliding surface, etc.. It will be understood that this is not an exhaustive list. The spool assembly holding arrangement 160 may include an engagement part 162 which is configured to engage at least one of a part of the spool support carriage 115 and a part of the first holding arrangement 150, for example the holding member 153. The engagement part 162 may be a pad, for example. The engagement part 162 may have a high coefficient of friction. The engagement part 162 may be resilient or include a resilient portion. It will be understood that the engagement part 162 is not an essential feature.

The spool rotation holding arrangement 152 and the spool assembly holding arrangement 160 may be configured and/or arranged to co-operate with one another. The part with which the spool assembly holding arrangement 160 is configured to engage, may be a part of the spool rotation holding assembly 152, for example the holding member 153. The holding member 153 may be moveable between a holding position and a release position relative to the engagement part 162.

The holding member 153 may be biased towards the holding position relative to the spool assembly holding arrangement 160.

The spool assembly holding arrangement 160 may include or co-operate with a release mechanism. The release mechanism of the spool assembly holding arrangement 160 may be shared with the release mechanism of the spool rotation holding assembly 152. The release member 129 may be operable to move the holding member 153 out of engagement with the spool assembly holding arrangement 160, for example.

In examples, the or each spool assembly may be moveable substantially arcuately relative to the body. The majority of the features of an apparatus where the or each spool assembly may be moveable substantially arcuately relative to the body are the same as or similar to those wherein the or each spool assembly is moveable substantially linearly relative to the body. The features and/or configuration of the spool assembly transport arrangement may exhibit some differences, for example.

A tape transfer apparatus 210 having a tape drive apparatus for transferring tape from one of the spools 218, 220 to the other spool 220, 218 mounted on respective spool supports 214, 216, is shown in FIGS. 5 and 6 for example. Features the same as or similar to those described above, in relation to tape transfer apparatus 10, 110 are given the same reference numerals, but prefixed with a [symbol] 2 [symbol] .

The spool supports 214, 216 may be mounted on the spool support carriage 215. The spool support carriage 215 may include a curved part. The or each spool motor 224, 226 may be mounted on a spool motor carriage 225. The or each spool motor 224, 226 may include a coupling 234, 236 to couple the spool motor 224, 226 to a respective one of the spool supports 214, 216. The or each spool assembly may include any or all of the following: a spool support 214, 216, an associated spool 218, 220, the spool support carriage, 215, the spool motor carriage 225, a spool motor 224, 226. The or each spool assembly may be configured to move substantially arcuately relative to the body 11, for example in directions indicated by the double headed arrow marked Y in FIG. 5.

A spool assembly transport arrangement 240 may include a spool assembly transport assembly 240a to enable movement of one or both of the spool supports 214, 216 and their respective spools 218, 220 relative to the body 211. The spool transport assembly 240a may include or co-operate with the spool support carriage 215. The spool assembly transport assembly 240a may include a first pivot pin 241. The spool support carriage 215 may be rotatable relative to the body 211 about the first pivot pin 241. The first pivot pin 241 may be fixed to the first part 212 of the body 211, for example.

The spool assembly transport arrangement 240 may include a spool motor transport assembly 240b to enable the movement of one or both of the spool motors 224, 226 relative to the body 211. The spool motor transport assembly 240b may include or co-operate with the spool motor carriage 225. The spool motor carriage 225 may be pivotable relative to the body 211. The spool motor carriage 225 may be moveable relative to the motor supporting member 227. The spool motor carriage 225 may be pivotable relative to the motor support member 227 about a second pin 243.

The spool assembly transport arrangement 240 may include a track 244. The track 244 may include a rail or a pair of rails, for example. The track 244 may be curved. The track 244 may be fixed to the body 211. The track 244 may be fixed to a second part 213 of the body 211. The track 244 may be fixed to the spool motor support member 227. The track 244 may be arcuate or curvilinear. The spool motor carriage 225 may include a formation 245 which co-operates with the track 244 to facilitate movement of the spool motor carriage 225 and the or each motor 224, 226 mounted thereto, relative to the body 211. The track 244 may be configured to guide the spool motor carriage 225 in a substantially arcuate or curvilinear path relative to the motor support member 227.

The spool assembly transport arrangement 240 may include a drive mechanism 246. The drive mechanism 246 may include one or motors 247. The drive mechanism 246 may include a transmission. The drive mechanism 246 may be operable to enable movement of the or each spool assembly relative to the body 211, for example by enabling movement of the spool support carriage 215 about the first pivot pin 241 and/or movement of the spool motor carriage 225 about the second pin 243 and/or along the track 244.

The tape transfer apparatus 210 may include a spool holding arrangement 250, similar to that described above in relation to the tape transfer apparatus 110. Examples of the apparatus 210, for instance as shown in FIGS. 5 and 6, may include a spool rotation holding arrangement 252. The spool rotation holding arrangement 252 is similar in form and operation to the spool rotation holding arrangement 152. A holding member 253, which may be in the form of a plate, may be provided. The spool support holding member 253 may be attached to the spool support carriage 215 and/or may be attached to the body 211. The spool support holding member 253 may have a similar shape to the spool support carriage 215. The spool support holding member 253 may include an opening to receive a part of at least one of the spool supports 214, 216. The spool support holding member 253 may include a pair of openings, each opening being configured to receive a part of a corresponding spool support 214, 216.

The spool support holding member 253 may be engageable with an engagement member 254 associated with one or both spool supports 214, 216. The or each engagement member 254 may be associated with a corresponding spool support 214, 216. The or each engagement member 254 may be a collar which is fixed to or part of a corresponding spool support 214, 216. Additionally or alternatively, the spool support holding member 253 may be configured to engage a part of a spool 218, 220 supported by a corresponding one of the spool supports 214, 216.

The holding member 253 may be hinged or pivotable relative to the body 211 and/or relative to one or both of the spool supports 214, 216. The holding member 253 may be moveable between a holding position and a release position relative to the spool supports 214, 216. When the spool support holding member 253 is in the first, holding position, the spool support holding member 253 is operable to inhibit or prevent rotation of one or both of the spool supports 214, 216. When the spool support holding member 253 is in its second, release position, the or each support 214, 216 is able to rotate about its axis relative to the body 211.

The spool support holding member 253 may be biased towards one of the first position and the second position. The spool support holding member 253 may be urged towards and/or held in its biased position by a biasing member, for example a spring or magnet. The biasing member may be positioned between the spool support carriage 215 and the spool supports 214, 216. The spool assembly holding arrangement 250 may include or co-operate with a release mechanism. The release mechanism may include a release member 229.

The release member 229 may co-operate with the spool holding arrangement 250. The release member 229 may co-operate with the spool rotation holding arrangement 252 to release the spool support holding member 253 from its biased position. The release member 229 may co-operate with the spool assembly holding arrangement 250 when the first part 212 and the second part 213 of the body 211 are engaged with one another, for example. The release member 229 may be arranged such that when the first part 212 and the second part 213 of the body 211 are engaged with one another, the release member 229 pushes the spool support holding member 253 out of its biased position, and towards its release position.

The apparatus 210 may include a spool assembly holding arrangement 260. The spool assembly holding arrangement 260 may inhibit or prevent movement of the or each spool support 214, 216 relative to the body 11. The spool assembly holding arrangement 260 may be configured to inhibit or prevent at least one of linear, e,g. lateral, arcuate or curvilinear movement of one or both of the spool supports 214, 216 relative to the body 211. The spool assembly holding arrangement 260 may be configured and/or operable to inhibit or prevent at least one of linear, e.g. lateral, arcuate or curvilinear movement of one or both spool assemblies relative to the body 211. The spool assembly holding arrangement 260 may be configured and/or operable to inhibit or prevent movement of any or all of the following relative to the body 211, individually or in combination: one or both of the spool supports 214, 216, the spool support carriage 215, the or each spool motor 224, 226, the spool motor carriage 225, and any other parts fixed or coupled to any of the aforementioned parts.

The spool assembly holding arrangement 260 may be attached to the body 211, for example to the first part 212 of the body 211. The spool assembly holding arrangement 260 may include a first holding formation 261 configured to inhibit or prevent movement of the spool support carriage 215 relative to the body 211. The first holding formation 261 may include a bracket, for example. The first holding formation 261 may be of any appropriate type, for example a clip, detent, hook, catch, etc.. It will be understood that this is not an exhaustive list. The first holding formation 261 may be configured to engage a part of the or each spool assembly. The spool holding formation may co-operate with the spool rotation holding assembly 252. The first holding formation 261 may be configured to engage a part of the spool support carriage 215 and/or the spool support holding member 253, for example.

The spool rotation holding arrangement 252 and the spool assembly holding arrangement 260 may be configured and/or arranged to engage with one another. The part with which the spool assembly holding arrangement 260 is configured to engage, for example, the spool support holding member 253 and/or the spool support carriage 215, may include an engagement feature configured for engagement with a part of the first holding member 261. Such an engagement feature may be configured to receive a part of the first holding member 261. The engagement feature may be in the form of a depression, hole or catch, for example. It will be understood that any kind of appropriate engagement feature may be provided, and this is not an exhaustive list.

A release mechanism of the spool assembly holding arrangement 260 may be shared with the release mechanism of the spool rotation holding assembly 252. The release member 229 may be operable to move the spool support holding member 253 out of engagement with the spool assembly holding arrangement 260, for example.

FIG. 7A shows the apparatus 110, 210 in the first holding position. In this position, the first part 112, 212 and the second part 113, 213 of the body 111, 211 are disconnected from one another. The release member 129, 229 is disengaged from the first part 112, 212 of the body 211, 212. In this position, the spool rotation holding arrangement 152, 252 is operable to inhibit or prevent rotation of at least the spool mounts 214, 216. The spool rotation holding arrangement 152, 252 is biased towards its first position by the biasing member 156, 256. The biasing member 156, 256 biases the holding member 153, 253 towards its holding position, in which the or each engagement formation 154, 254 engages a part of the corresponding spool support 114, 214, 116, 216 (and/or a part of a tape spool 118, 218, 120, 220 mounted on the spool supports 114, 214, 116, 216). Friction between the or each engagement formation 154, 254 and the corresponding spool support 114, 214, 116, 216 and/or corresponding spool 118, 218, 120, 220 inhibits or prevents rotation of the spool supports 114, 214, 116, 216 (and the spools 118, 218, 120, 220) relative to the first part 112, 212 of the body 111, 211. This inhibits or prevents tape from unwinding from or winding onto the or each spool 118, 218, 120, 220 whilst the first part 112, 212 of the body 111, 211 is disconnected from the second part 113, 213 of the body 111, 211.

In the first position, the spool assembly holding arrangement 160, 260 may also be operable. When the first part 112, 212 and the second part 113, 213 of the body 111, 211 are disengaged from one another, the release member 129, 229 is disengaged from the first part 112, 212 of the body 111, 212. The release part is disengaged from the spool rotation holding member 153, 253 and the spool assembly holding arrangement 160, 260. The release member 129, 229 may be a connecting part which enables or facilitates connection of the first part 112, 212 and the second part 213, 213 of the body 111, 211 together.

In the examples shown, in the first position, the holding member 153, 253 engages the first holding formation 161, 261 of the spool assembly holding arrangement 160. Friction between the spool holding member 153, 253 and the first holding formation may inhibit or prevent movement of the spool support carriage 115, 215 relative to the body 111, 211, for example relative to the first part 112, 212 of the body 111, 211. It will be appreciated that the spool support holding arrangement 160, 260 may engage a part associated with the spool support carriage 115, 215, or the spool support carriage 115, 215 itself to inhibit or prevent movement of the spool support carriage, 115, 215 relative to the body 111, 211 or a part 112, 212, 113, 213 of the body 111, 211.

It will be appreciated that the spool rotation holding arrangement 152, 252 and the spool assembly holding arrangement 160, 260 may be operable independently or co-operatively. In other words, when the apparatus 110, 210 is in the first, holding position at least one of the following is inhibited or prevented:
rotation of at least one spool support 114, 214, 116, 216;
rotation of at least one spool of tape 118, 218, 120, 220;
movement of at least one spool support 114, 214, 116, 216 relative to the body 111, 211 or a part 112, 212, 113, 213 of the body 111, 211.

FIG. 7B shows the apparatus 110, 210 in the second, release position. In the release position, the first part 112, 212 and the second part 113, 213 of the body 111, 211 are engaged with one another. In this position, the release member 129, 229 engages a part of the spool rotation holding assembly 152, 252. In the example shown engagement (or mutual proximity, at least) of the two parts 112, 212, 113, 213 of the body 111, 211 causes the release member 129, 229 to engage the holding member 153, 253. Movement of the first part 112, 212 relative to the second part 113, 213 overcomes the biasing force of the biasing member 156, 256 and enables the spool rotation holding assembly 152, 252 and/or the spool assembly holding assembly 160, 260 to move to its respective release position. In the example shown, the holding member 153, 253 pivots away from the engagement formation 154, 254 of the spool supports 114, 214, 116, 216, and the spool rotation holding assembly 152, 252 is released. The holding member 153 disengages from the first holding member 161, 261 of the spool assembly holding arrangement 160, 260 such that the spool assembly holding arrangement 160, 260 is in its release position. This enables rotation of the spool mounts 114, 214, 116, 216 and the corresponding tape spools 118, 218, 120, 220 (when mounted) about their respective axes. The spool support carriage 115, 215 is able to move relative to the body 111, 211, and therefore the or each spool assembly is able to move relative to the body 111, 211.

Provision of the spool assembly holding assembly 152, 252 enables the spool support carriage 115, 215 to remain stationary relative to the body 111, 215 [symbol] the holding member 153, 253 being in its holding position enables the spool support carriage 115, 215 to remain in a substantially constant orientation and/or position relative to the body 111, 211.

The release position of the spool rotation holding arrangement 152, 252 and/or the spool support holding arrangement 160, 260 may be a printing position, i.e. a position in which the spool supports 114, 214, 116, 216 and/or the tape spools 118, 218, 120, 220 are permitted to move in such a manner that printing operations may be carried out.

It will be appreciated that the part responsible for releasing the spool rotation holding arrangement 150, 250 and/or the spool support holding arrangement 160, 260 need not be a part that is responsible for, enables or assists in connecting the two parts 112, 113, 212, 213 of the body 111, 211 together, but that this may be an elegant solution. Connection of the two parts 112, 113, 212, 213 of the body 111, 211 with one another (for example by insertion of the cassette) may automatically release the spool rotation holding arrangement 150, 250 and/or the spool assembly holding arrangement 160, 260.

The examples described above enables the spool motors 124, 126, 224, 226 to move relative to the body 111, 211 in a manner corresponding with the movement of the corresponding spool support 114, 214, 116, 216. Alternatively, it may be possible or preferable for the or each spool motor 124, 126, 224, 226 to remain substantially stationary relative to the body 111, 211 whilst the spool supports 114, 116 214, 216 (and the associated spools 118, 120, 218, 220) move relative to the body 111, 211 and/or each other.

It will be appreciated that the invention may be embodied in a tape transfer apparatus where the spool supports and spools are directly mounted in the apparatus, rather than in a two-part body which enables the insertion of the spools into the apparatus by means of a [symbol] cassette [symbol] arrangement, for example. In such an example, the spools of tape are mounted on to the respective spool supports, which may be permanently coupled to the or each spool motor and the tape is arranged in the tape path by an operator. Such an apparatus may still include a spool assembly transport arrangement to enable the or each spool assembly to move relative to the body. A spool holding arrangement may be unnecessary in such a configuration.

An example of a tape transfer apparatus 310 is shown in FIG. 9A and 9B. Features of the tape transfer apparatus 310 which are the same as or similar to those described above have the same reference numerals with a [symbol] 3 [symbol] prefix.

The spool supports 314, 316 may be mounted on a spool support carriage 315 which is moveable relative to the body 311. The spool support carriage may be moveable substantially linearly and/or arcuately relative to the body 311. The spool motors 324, 326 may be mounted on the motor supporting member 327, and the motor supporting member 327 may be fixed relative to the body 311. A spool support member which is moveable relative to the body 311 may be omitted. The or each spool assembly in the tape transfer apparatus 310 may include a spool support 314, 316, and a corresponding spool. Movement of the or each spool assembly relative to the body 311 may be enabled by a spool support transport assembly 340a, which may be similar to the arrangements described above. Since the spool supports 314, 316 may not be directly coupled to the respective motors 324, 326, if the spool supports 314, 316 are moveable relative to the body 311 whilst the motors 324, 326 remain in a fixed position relative to the body 311, the tape drive assembly 322 includes a transmission arrangement 370, to transmit drive from each motor 324, 326 to the corresponding spool support 314, 316. The transmission may include one or more belts associated with each spool support 314, 316, to enable the rotation of each spool support. Alternative arrangements may be possible, for example a rack and pinion arrangement.

The tape transfer apparatus may include a controller. The controller may control functions of the tape transfer apparatus. Where the tape transfer apparatus is a printing apparatus, the controller may control printing functions, movement of the printhead and/or the tape relative to one another and/or a substrate and/or the body of the apparatus. In a tape transfer apparatus of the kind described herein, i.e. where a spool assembly is moveable relative to the body, the controller may control such movement. A sensor, for example a Hall effect sensor, may be provided to detect the position of a part of the spool assembly, for example the spool support carriage, relative to the body and/or another part of the apparatus, for example another part of the spool assembly. A sensor may be provided to detect the position of a part of the or each spool motor (and/or the spool motor carriage) relative to the body and/or relative to another part of the apparatus. The position data obtained by the sensor may be provided to the controller. The controller may use the position data and/or knowledge of the movement of the spool motors to control movement of the spool assembly transport arrangement.

Position data obtained by the sensor may be used to initialise the tape transfer apparatus. During initialisation, or prior to start up of the apparatus, the position of the spool assembly transport arrangement may be set and/or adjusted. The appropriate position(s) of the spool supports, and/or the position(s) of the spool motors, and/or their respective carriages may be determined and the spool assembly transport arrangement controlled appropriately to achieve the appropriate positions. The appropriate position(s) may depend upon each spool diameter, and/or a ratio of the spool diameters. Manual adjustment of the position(s) may be possible, for example to allow broken or partially used tapes to be used.

In a two-part body apparatus (for example an apparatus having a cassette in which the spools are mounted), it may be necessary to ensure that the spool support carriage is substantially aligned relative to the spool motor carriage when the two parts of the body are engaged, and the spool supports are coupled with the respective spool motors. The position data from the sensor may be used to adjust the position of the spool support carriage or the spool motor carriage relative to the body and relative to the other carriage.

The spool support carriage and the spool motor carriage may be moved co-operatively or independently of one another.

Where the tape transfer apparatus is a printing apparatus, movement of the or each carriage relative to the body and/or to each other may be carried out during a non-printing period.

Control of the position of the or each spool assembly relative to the body may include movement of the or each spool assembly, or a part thereof.

The movement of the or each spool assembly relative to the body (not the rotation of the spool supports) enables the size of spool which may be used in the apparatus to be optimised, e.g. maximised. Movement of the or each spool assembly, or a part thereof, relative to the body may depend upon the change in diameter of one or both spools during tape transfer. For example, as the diameter of the take up spool increases, the distance between the centre of the take up spool and a wall of the body and/or a guide member, may be increased. Methods of determining the diameter of a spool during tape transfer are known in the art. The control of movement and/or the position of each spool support may depend upon the diameter of the spool mounted upon the spool support and/or the diameter of the spool mounted upon the other spool support.

Control of the movement and/or position of the or each spool assembly, or a part thereof, may depend upon a relationship between the diameters of the spools mounted on the two spool supports. The relationship may be a sum, difference or ratio, for example.

Since the supply spool typically decreases in diameter as the take up spool diameter increases, the supply spool may be moved closer to a wall of the body and/or a guide member. It is important to ensure that minimum clearances between adjacent portions of tape in the tape path and between tape and another part of the apparatus, e.g., a wall of the body are maintained. The controller may be responsible for controlling the spool transport assembly, including the drive mechanism(s) in such a way as to ensure that the minimum clearances are maintained. The minimum clearance values may be input or set during manufacture and/or commissioning of the apparatus. The controller may take into account some or all of the equations described above, and may take into account measurements/dimensions determined in accordance with the methods described above.

It will be understood that each example of a tape transfer apparatus described herein may be operated bi-directionally, that is, tape may be transferred in both directions between the spools mounted on the spool supports.

The or each spool motor may remain stationary whilst the or each spool support moves relative to the body. The or each spool motor may move relative to the body, together with the or each spool support. The or each spool motor and/or the or each spool support may move together or separately and may move linearly and/or arcuately relative to the body.

The determination of the largest spool which may be accommodated in a tape transfer apparatus may take into account the range of movement of the or each spool assembly. The range of movement of a spool assembly and the maximum diameter of a spool may be dependent on each other.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A tape transfer apparatus including a body and two spool supports each spool support being suitable for supporting a spool of tape, and a tape drive apparatus which is operable to transfer tape between spools supported on the spool supports, characterised in that a position of at least one of the spool supports relative to the body is adjustable.

2. A tape transfer apparatus according to claim 1 wherein the position of the at least one spool support is adjustable relative to the position of the other spool support.

3. A tape transfer apparatus according to claim 1 wherein the position of each spool support is adjustable relative to the body whilst a distance between the spool supports remains substantially constant.

4. A tape transfer apparatus according to any preceding claim wherein the position of the or each spool support is adjustable in accordance with the diameter of a respective spool of tape mounted on the spool support.

5. A tape transfer apparatus according to any preceding claim including a spool support carriage upon which at least one of the spool supports is mounted, the spool support carriage being moveable relative to the body to adjust the position of the or each spool support mounted thereon relative to the body.

6. A tape transfer apparatus according to any preceding claim including at least one spool motor for rotating at least one of the spool supports and wherein a position of the spool motor relative to the body is adjustable.

7. A tape transfer apparatus according to claim 6 wherein each spool support is rotatable by a respective spool motor, and the position of each spool motor relative to the body is adjustable.

8. A tape transfer apparatus according to claim 6 or 7 including a spool motor carriage upon which the or each spool motor is mounted, the spool motor carriage being moveable relative to the body to adjust the position of the or each spool motor mounted thereon relative to the body.

9. A tape transfer apparatus according to any of the preceding claims wherein the position of the at least one spool support is adjustable relative to the body in at least one of linear or curvilinear motion.

10. A tape transfer apparatus according to any of claims 3 to 9 wherein the position of each spool support is adjustable relative to the body in at least one of a linear or curvilinear motion.

11. A tape transfer apparatus according to any of claims 6 to 10, wherein movement of the or each spool motor to adjust the position of the or each spool motor relative to the body corresponds with movement of at least one of the spool supports relative to the body to adjust the position of the at least one spool relative to the body.

12. A tape transfer apparatus according to any of the preceding claims including a controller operable to control movement of a component of the tape transfer apparatus other than the body, relative to the body.

13. A tape transfer apparatus according to claim 12, as dependent upon claim 3 wherein the controller is operable to control movement of the or each spool support to adjust the position of the or each spool support relative to the body.

14. A tape transfer apparatus according to claim 12, as dependent upon claim 5 wherein the controller is operable to control movement of the spool support carriage relative to the body.

15. A tape transfer apparatus according to any preceding claim wherein the body includes a first part and a second part.

16. A tape transfer apparatus according to claim 15 as dependent upon claim 6 wherein each spool support is mounted in one of the first part and the second part of the body and the at least one spool motor is mounted in the other of the first part and the second part of the body.

17. A tape transfer apparatus according to any preceding claim including a spool rotation holding apparatus to inhibit or prevent rotation of at least one of the spool supports about its own axis of rotation.

18. A tape transfer apparatus according to any preceding claim including a spool holding apparatus which is operable to inhibit or prevent movement of at least one of the spools relative to the body.

19. A tape transfer apparatus according to any preceding claim wherein the tape transfer apparatus is a transfer printing apparatus.

20. A method of operating a tape transfer apparatus according to any of the preceding claims, including controlling the rotation of each of the spool supports to enable tape to be transferred from one spool, mounted on a respective spool support, to another spool, mounted on the other spool support, and controlling a drive mechanism that is operable to adjust the position of at least one of the spool supports relative to the body.

21. A method of operating a tape transfer apparatus according to claim 20 including controlling the drive mechanism to control the position of at least one of the spool supports in accordance with the diameter of the spool mounted on the at least one spool support.

22. A method of operating a tape transfer apparatus according to claim 20 or 21 including adjusting the position of both spool supports relative to the body in accordance with the diameter of at least one of the spools.

23. A method of operating a tape transfer apparatus according to any of claims 20 to 21 wherein the drive mechanism is operable to control the position or movement of at least one of the spool supports in accordance with a rate of change of diameter of at least one of the spools.

24. A method of operating a tape transfer apparatus according to any of claims 18 to 21 including determining the largest spool of tape which may be accommodated in the tape transfer apparatus, taking into account at least one dimension of the body of the tape transfer apparatus.

25. A method of operating a tape transfer apparatus according to claim 21 wherein the method includes determining a range of adjustment of the position of at least one of the spool supports.

26. A method of operating a tape transfer apparatus according to any of claims 20 to 25 including adjusting the position of the at least one spool by displacing the at least one spool support substantially linearly relative to the body and/or displacing the at least one spool support substantially curvilinearly relative to the body.
